(19) United States
(12) Patent Application Publication
(10) Pub. No.: US 2011/0119462 A1
(43) Pub. Date: May 19, 2011

(54) METHOD FOR RESTORING AND MAINTAINING SOLID-STATE DRIVE PERFORMANCE

(75) Inventors: Anthony Leach, Stockport (GB); Franz Michael Schuette, Colorado Springs, CO (US)

(73) Assignee: OCZ Technology Group, Inc., San Jose, CA (US)

(21) Appl. No.: 12/945,100

(22) Filed: Nov. 12, 2010

Related U.S. Application Data
(60) Provisional application No. 61/262,659, filed on Nov. 19, 2009.

(51) Int. Cl. G06F 12/02

(52) U.S. Cl. 711/166; 711/E12.002

(57) ABSTRACT

A method of maintaining a solid-state drive so that free space within memory blocks of the drive becomes free usable space to the drive. The drive comprises cells organized in pages that are organized in memory blocks in which at least user files are stored. A defragmentation utility is executed to cause at least some of the memory blocks that are partially filled with data and contain file fragments to be combined or aligned and to cause at least some of the memory blocks that contain only invalid data to be combined or aligned. A block consolidation utility is then executed to eliminate at least some of the partially-filled blocks by consolidating the file fragments into a fewer number of the memory blocks. The consolidation utility also increases the number of memory blocks that contain only invalid memory. All of the memory blocks containing only invalid data are then erased.

### CROSS REFERENCE TO RELATED APPLICATIONS

This application claims the benefit of U.S. Provisional Application No. 61/262,659, filed Nov. 19, 2009, the contents of which are incorporated herein by reference.

### BACKGROUND OF THE INVENTION

The present invention generally relates to memory devices for use with computers and other processing apparatuses. More particularly, this invention relates to a high speed non-volatile (permanent memory-based) mass storage device and a method for maintaining high performance levels as the drive becomes filled with data.

Mass storage devices such as advanced technology (ATA) or small computer system interface (SCSI) drives are rapidly adopting non-volatile memory technology, such as flash memory components (chips) or another emerging solid-state memory technology, including phase change memory (PCM), resistive random access memory (RRAM), magnetoresistive random access memory (MRAM), ferromagnetic random access memory (FRAM), organic memories, or nanotechnology-based storage media such as carbon nanofiber/nanotube-based substrates. Currently the most common solid-state technology uses NAND flash memory components as inexpensive storage memory, often in a form commonly referred to as a solid-state drive (SSD).

Briefly, flash memory components store information in an array of floating-gate transistors, referred to as cells. The cell of a NAND flash memory component has a top gate (TG) and a floating gate (FG), the latter being sandwiched between the top gate and the channel of the cell. The floating gate is separated from the channel by a layer of tunnel oxide. Data are stored in (written to) a NAND flash cell in the form of a charge on the floating gate which, in turn, defines the channel properties of the NAND flash cell by either augmenting or opposing a charge on the top gate. This charge on the floating gate is achieved by applying a programming voltage to the top gate. Data are erased from a NAND flash cell by applying an erase voltage to the device substrate, which then pulls electrons from the floating gate. The charging (programming) of the floating gate is unidirectional, that is, programming can only inject electrons into the floating gate, but not release them.

NAND flash cells are organized in what are commonly referred to as pages, which in turn are organized in what are commonly referred to as memory blocks (or sectors). Each block is a predetermined section of the NAND flash memory component. A NAND flash memory component allows data to be stored, retrieved and erased on a block-by-block basis. For example, erasing cells is described above as involving the application of a positive voltage to the device substrate, which does not allow isolation of individual cells or even pages, but must be done on a per block basis.

NAND flash-based SSDs eliminate mechanical latencies encountered by rotating mass storage devices such as hard disk drives (HDDs), and can have access times of about 100 to about 200 times faster than HDDs. In addition, modern memory controllers use multi-channel back-end configurations to address the NAND flash memory devices by virtue of an abstraction layer of the controller, which translates protocol signals received from a host system from logical addresses into physical addresses on the memory components to which the data are written or from which data are read. Fast access times of NAND flash memory components in combination with controllers using multi-channel back-end configurations allow sustained transfers at the upper limit of the currently prevailing Serial ATA (serial advanced technology attachment, or SATA) interface specifications, and random access transfers of approximately 100 to 500 times above those of electromechanical hard disk drives, depending on the workload.

Compared to hard disk drives, however, solid-state drives age extremely fast. The term aging is used in this context to describe performance degradation rather than failure of the drive. Briefly, a new drive will initially have enough space to write data to a new block every time a write request is serviced. However, as files are modified they are not rewritten to the same physical location but, rather, they are stored on a different block. The original block may yet contain other files that are still in use. Because, as mentioned above, individual files cannot be erased without erasing the entire block, and moreover, the files cannot be overwritten, the drive will fill up very quickly with garbage data.

As soon as there are no virgin blocks available, the drive is required to start shuffling data on the next write request. This includes filling in gaps and further shuffling existing data in an effort to consolidate them on single blocks, thereby freeing up blocks that now only contain invalid data that are recognized as garbage, i.e., there are no more pointers associated with them. The next step before the outstanding request can be serviced is to discard garbage by erasing blocks containing only invalid data. Only after this sequence has been completed can the new data be written to the drive. The effect can be described as aging of the solid-state drive due to a significant degradation of the drive's write performance.

In the case of reads, the situation is not as grave, though performance is degraded as a result of the drive having scattered file fragments. Typically a relatively minor yet significant degradation of read performance is a side effect of drive aging. Within this scenario, in should be borne in mind that the drive itself does not need to be completely full to exhibit significant performance degradation. For example, ninety percent of a drive may appear free to the host system, yet the space on the drive is not usable until maintenance is performed in the form of consolidating fragments and discarding garbage.

For comparison, the situation is different with hard disk drives in that any sector can simply be overwritten with new or updated data without any additional intermediate steps required. Moreover, a wealth of drive conditioning tools are available to erase even the last hint of previous data on the media by writing “0”s and “1”s to the platter. The effect in this case is a “leveling of the field,” that is, if certain bits in a sector have developed a bias from repetitive reprogramming to the same value, this can be reversed by alternating “zero-fills” with “one-fills” to effectively restore a drive with even a heavy usage history to almost a virgin state.

From the fundamental functional differences between NAND flash-based SSDs and rotatable media-based HDDs, it is apparent that different strategies are needed for maintenance of the solid-state storage media, so that free space truly becomes free usable space to the host system in which the SSD operates.

### BRIEF DESCRIPTION OF THE INVENTION

The present invention provides a method for maintaining a solid-state drive, in adaptation of specific operating parameters of solid-state drives in general and NAND flash technology specifically. The method is performed so that free space within memory blocks of the drive becomes free usable space to the drive and to a host system in which the drive operates. In this manner, the method is able to increase the performance level of the solid-state drive.

According to one aspect of the invention, the solid-state drive has at least one solid-state memory device and comprises cells organized in pages that are organized in memory blocks in which user files and system files of an operating system for the solid-state drive are stored. The method includes executing a defragmentation utility to cause at least some of the memory blocks that are partially filled with data and contain file fragments to be combined or aligned and to cause at least some of the memory blocks that contain only invalid data to be combined or aligned. A block consolidation utility is then executed to eliminate or otherwise free-up at least some of the partially-filled blocks by consolidating the file fragments of at least some of the partially-filled blocks into a fewer number of the memory blocks. The block consolidation utility also increases the number of memory blocks that contain only invalid memory. All of the memory blocks containing only invalid data are then erased.

A technical effect of the invention is that, by consolidating and erasing memory blocks containing invalid data, the cells of these blocks can be immediately reprogrammed, without any additional intermediate steps (for example, housekeeping and/or conditioning steps) required. As such, the free space within these blocks truly becomes free usable space to the host system in which the SSD operates.

Other aspects and advantages of the invention will be better appreciated from the following detailed description.

### BRIEF DESCRIPTION OF THE DRAWINGS

FIG. 1 schematically represents a new solid-state drive that does not contain any data, and with all blocks set to FF byte values.

FIG. 2 schematically represents the drive of FIG. 1 after installation of an operating system and some application software, with the result that a few blocks are fully utilized but the majority of used blocks is only partially filled with data.

FIG. 3 schematically represents the drive of FIG. 1 after extended use, resulting in the absence of free blocks and with most used blocks being only partially filled with data.

FIG. 4 schematically represents the drive of FIG. 1 after deletion and/or archiving of unnecessary data, resulting in some blocks containing only invalid data.

FIG. 5 schematically represents the drive of FIG. 1 after defragmentation, resulting in blocks containing file fragments being combined/aligned and blocks containing only invalid data being combined/aligned.

FIG. 6 schematically represents the drive of FIG. 1 after consolidation in which valid data from different blocks are combined within a fewer number of blocks to increase block utilization, resulting in free blocks but also resulting in a majority of the blocks containing only invalid data.

FIG. 7 schematically represents the drive of FIG. 1 after erasing all of the blocks represented in FIG. 6 as containing only invalid data.

### DETAILED DESCRIPTION OF THE INVENTION

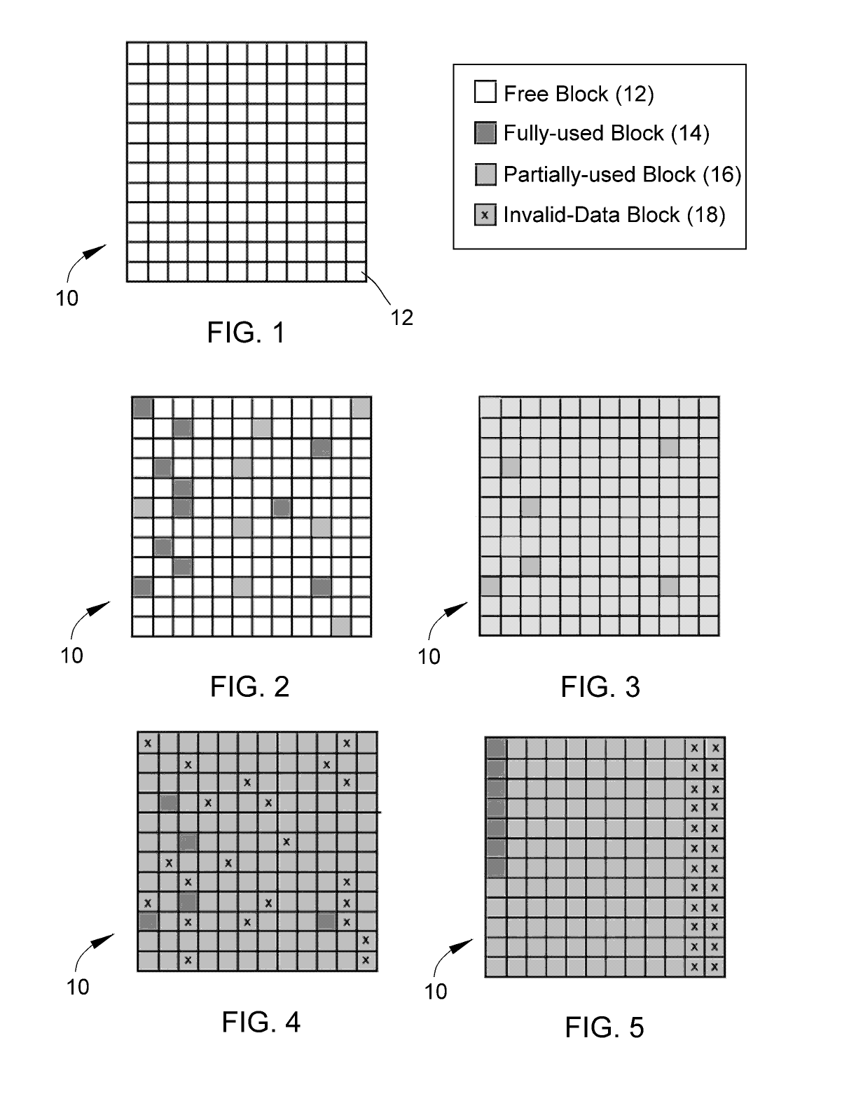

Mass storage devices of interest to the invention are non-volatile memory-based mass storage devices, referred to herein as solid-state drives (SSDs) as a result their use of solid-state memory components (chips), a particular example of which is a NAND flash memory component. As previously noted, NAND flash memory components allow data to be stored, retrieved and erased on a block-by-block basis, with each block (sector) being a predetermined section of the component and containing multiple pages, each of which in turn comprises multiple flash cells. Memory blocks of such a drive 10 are schematically represented in FIGS. 1 through 7, and will serve to explain the effects of steps performed according to a preferred embodiment of the invention. These blocks are identified by a key associated with FIG. 1 as “free blocks” 12, or “fully-used blocks” 14, or “partially-used blocks” 16, or “invalid-data blocks” 18, which reflects the amount or type of data contained by these blocks as will be explained in more detail below. While the preferred embodiment of the invention will be discussed in the context of a NAND flash memory SSD, it is foreseeable that other memory technologies could benefit from the method described below, and particular those memory technologies whose memory units could be described as being organized in “pages” and “blocks” or their equivalents. Such technologies are also within the scope of the invention.

Three parameters having significant influence on the performance of a solid-state drive are the effective host transfer rate (the transfer from a host system to the drive), the internal transfer rate (the bandwidth achievable between the drive's controller and the solid-state storage media of the drive), and the availability of space on the storage media to which data can be written. The effective host transfer rate is defined primarily by the interface protocol, which for most NAND flash memory SSDs will be either IEEE 1394 Firewire, USB 2.0 (with USB 3.0 emerging), or Serial ATA. The latter supports 3.0 Gbit/sec and is moving toward 6.0 GB/sec in the near future. The internal transfer rate is defined by the data frequency, the channel width and the number of channels that interface the abstraction layer of the controller with the actual memory components. Neither one of these two parameters can be altered in an existing NAND flash memory SSD.

The third parameter mentioned above is the availability of free usable space on the SSD. As used herein, free usable space means that the space is available for immediate writes without any additional intermediate housekeeping or conditioning steps, in contrast to what will be referred to as “free space” that may appear to be free to the host system, yet the space on the drive is not usable until maintenance is performed in the form of consolidating fragments and discarding garbage. The first prerequisite to meet this condition is, of course, the availability of free capacity on a drive. The drive 10 represented in FIG. 1 can be referred to as a “new” drive in that it does not contain any data and all of its memory blocks are free blocks 12 set to FF byte values. FIG. 2 schematically represents the drive 10 after installation of an operating system and some application software, with the result that the memory blocks of the drive 10 contain system files and user files of the operating system and application software, respectively. Only a few of the blocks are fully utilized, in other words, completely filled with data, and therefore designated as fully-used blocks 14 in FIG. 2. The majority of used blocks (in other words, blocks containing data) are only partially filled with data, and therefore designated as partially-used blocks 16). Finally, FIG. 3 schematically represents the same drive 10 after extended use, resulting in the absence of any free blocks 12 on the drive 10. Some blocks on the drive 10 are indicated as being fully-used blocks 14, whereas most of the blocks are indicated as being only partially-used blocks 16. As a result, although there is free space in the partially-used blocks 16, there is no free usable space (free capacity) on the drive 10 because any update of existing data will be required to read-modify-write the entire page while preserving the page number. This can done only if the page is written to another block and typically the entire source block will have to be rewritten in the process. In absence of free blocks, this will require complete erasing of a target block as a prerequisite for storing the modified data.

According to a preferred aspect of the invention, the creation of free usable space (free capacity) on the drive 10 whose condition is represented by FIG. 3 can be initiated by analyzing the blocks of the drive 10, followed by deleting unnecessary files or by off-loading rarely accessed data to a different drive, for example, a hard disk drive. Preferably, system files of the operating system are distinguished from user files of the application software that have been stored on the drive 10. In a preferred embodiment of the invention, a scheduled or user-initiated time-stamp-based scan of the drive 10 can be initially performed, by which user files are analyzed and consolidated into logical groups. For example, the user files can be grouped according to their access frequencies based on a predefined interval. In a basic approach, user files can be grouped into higher frequency-accessed user files and lower frequency-accessed user files, with the latter user files being identified on the basis that they have not been accessed within the predefined interval and are, therefore, deemed to be non-critical to the performance of the system. The system can then present to the user a list of the lower frequency-accessed user files. In certain embodiments, the host system can prompt the user for permission to delete those user files of the lower frequency-accessed user files which are deemed to be unnecessary to the system, or otherwise archive rarely used files to create free space on the drive 10 in order to enable further steps represented in FIGS. 5 through 7. FIG. 4 schematically represents that the deletion and/or archiving of data associated with lower frequency-accessed user files results in some blocks containing only invalid data, and therefore designated as invalid-data blocks 18.

This analysis and deletion/archiving process described above is optional to the invention, but if performed will enable subsequent steps described below to be more efficient, with a higher percentage of free space being created on the drive 10. FIG. 5 schematically represents one of these subsequent steps as a defragmentation step performed on the drive 10, which results in some of the partially-used blocks 16 containing file fragments being combined/aligned, as well as the invalid-data blocks 18 being combined/aligned. Defragmenting a solid-state drive may be viewed as somewhat paradoxical since there is no real need to defragment if there is no physical fragmentation, similar to what occurs with hard disk drives. However, because a NAND flash memory component is organized into blocks and pages, initial access latencies for page misses are higher than for in-page accesses. Different utilities will result in different levels of defragmentation. However, in the preferred embodiment, execution of the defragmentation utility coalesces file fragments into coherent strings of data, as represented in FIG. 5.

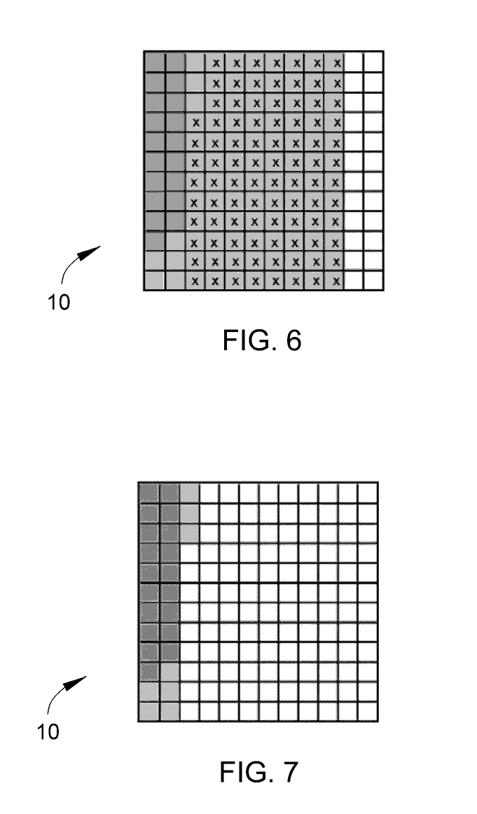

FIG. 6 schematically represents the result of performing a consolidation step on the drive 10, which results in valid data from different partially-used blocks 16 being identified and combined within a fewer number of blocks to increase block utilization. As evident from comparing FIG. 6 to FIG. 5, the number of fully-used blocks 14 has increased, whereas the number of partially-used blocks 16 containing valid data has been greatly decreased by consolidation. A further result is that all of the valid data from some blocks have been moved, and those blocks are now identified in FIG. 6 as free blocks 12. However, a majority of the blocks contain only invalid data as a result of the consolidation step moving their valid data to another block (for example, to create a fully-used block 12 or a partially-used block 14) so that only invalid data remain in these blocks, with the result that these blocks are now identified in FIG. 6 as invalid-data blocks 18. The benefit of consolidation can be explained with reference to an extreme case, in which a block has a single page with valid data while the remaining pages are filled with invalid data (garbage), with the result that the block appears to be full and therefore the system is unable to perform write accesses to the block. In the case where there are 128 pages per block, moving the valid data from the single page to another block with a higher percentage of valid data can result in a 128× reward in freeing up an erasable block that, following an erasing operation, yields free usable space on the drive 10.

FIG. 7 schematically represents the drive 10 after erasing all of the invalid-data blocks 18 of FIG. 6, converting these blocks to free blocks 12. Erasing these blocks 18, which essentially means writing all “1” values to the cells within the blocks 18, results in byte values of “FF” without subsequently programming any cells to lower levels. As a result, the cells of these blocks 18 can be reprogrammed immediately to any lower value, without any additional intermediate housekeeping or conditioning steps.

The method outlined above in reference to FIGS. 4 through 7, and especially the defragmentation, consolidation and erase steps of FIGS. 5 through 7, can be implemented to run at regularly scheduled intervals. In this manner, the present invention can be employed to maintain the performance of the drive 10 throughout its entire lifespan. Furthermore, all of the steps described in reference to FIGS. 4 through 7 could be incorporated into a single executable program that can be run on the host system automatically or after the user is prompted to do so.

While the invention has been described in terms of a specific embodiment, it is apparent that other forms could be adopted by one skilled in the art. For example, various physical configurations could be employed for the solid-state drive, as well as for the solid-state memory components used on the drive. Therefore, the scope of the invention is to be limited only by the following claims.

1. A method of increasing a performance level of a solid-state drive having at least one solid-state memory device and comprising cells organized in pages that are organized in memory blocks in which are stored user files and/or system files of an operating system for the solid-state drive, the method comprising:
executing a defragmentation utility to cause at least some of the memory blocks that are partially filled with data and contain file fragments to be combined or aligned and to cause at least some of the memory blocks that contain only invalid data to be combined or aligned;
executing a block consolidation utility to free-up at least some of the partially-filled blocks by consolidating the file fragments of at least some of the partially-filled blocks into a fewer number of the memory blocks, the block consolidation utility increasing the number of memory blocks that contain only invalid data; and then erasing all of the memory blocks that contain only invalid data to yield free blocks having free usable space for use by the solid-state drive.

2. The method of claim 1, further comprising the step of deleting at least some of the user files to create at least some of the memory blocks that contain only invalid data.

3. The method of claim 1, further comprising the step of archiving at least some of the user files onto a second drive to create at least some of the memory blocks that contain only invalid data.

4. The method of claim 3, wherein the archiving step comprises prompting a user for permission to archive some of the user files.

5. The method of claim 1, wherein at least some of the memory blocks are fully used and the step of executing the defragmentation utility causes at least some of the fully-used memory blocks to be combined or aligned.

6. The method of claim 1, wherein the step of executing the block consolidation utility creates memory blocks that do not contain valid data.

7. The method of claim 1, further comprising writing data to at least one of the memory blocks erased by the erasing step.

8. The method of claim 1, wherein all of the steps recited in claim 1 are executed by an executable program running on a host system to which the solid-state memory device is connected.

9. The method of claim 1, wherein the solid-state memory components are NAND flash memory components.

10. A method of increasing a performance level of a solid-state drive having at least one solid-state memory device and comprising cells organized in pages that are organized in memory blocks in which user files and system files of an operating system for the solid-state drive are stored, the method comprising:
analyzing the solid-state drive to identify the system files and the user files stored in the memory blocks and group the user files into at least higher frequency-accessed user files and lower frequency-accessed user files;
removing the lower frequency-accessed user files so that the higher-frequency accessed user files remain stored in the memory blocks, at least some of the higher-frequency accessed user files being stored in partially-used memory blocks of the memory blocks, and the removing of the lower frequency-accessed user files causes at least some of the memory blocks to contain only invalid data;
executing a defragmentation utility to cause at least some of the partially-used blocks containing file fragments to be combined or aligned and to cause at least some of the memory blocks that contain only invalid data to be combined or aligned;
executing a block consolidation utility to eliminate at least some of the partially-used blocks by consolidating the file fragments of at least some of the partially-used blocks into a fewer number of the memory blocks, the block consolidation utility increasing the number of memory blocks that contain only invalid memory; and then
erasing all of the memory blocks that contain only invalid data to yield free blocks having free usable space for use by the solid-state drive.

11. The method of claim 10, wherein the analysis step is performed according to a schedule defined with a host system to which the solid-state memory device is connected.

12. The method of claim 10, wherein the removing step comprises deleting at least some of the lower frequency-accessed user files and/or archiving at least some of the lower frequency-accessed user files onto a second drive.

13. The method of claim 10, wherein the removing step comprises deleting at least some of the lower frequency-accessed user files.

14. The method of claim 10, wherein the removing step comprises archiving at least some of the lower frequency-accessed user files onto a second drive.

15. The method of claim 14, wherein the archiving step comprises prompting a user for permission to archive the lower frequency-accessed user files.

16. The method of claim 10, wherein at least some of the memory blocks are fully used and the step of executing the defragmentation utility causes at least some of the fully-used memory blocks to be combined or aligned.

17. The method of claim 10, wherein the step of executing the block consolidation utility creates memory blocks that do not contain data.

18. The method of claim 10, further comprising writing data to at least one of the memory blocks erased by the erasing step.

19. The method of claim 10, wherein all of the steps recited in claim 1 are executed by an executable program running on a host system to which the solid-state memory device is connected.

20. The method of claim 10, wherein the solid-state memory components are NAND flash memory components.

21. A host system to which the solid-state memory device is connected and having means for performing the steps of claim 1.

22. A host system to which the solid-state memory device is connected and having means for performing the steps of claim 10.
